(19) United States
(12) Patent Application Publication
(10) Pub. No.: US 2009/0117991 A1
(43) Pub. Date: May 7, 2009

(54) Slot Machine Characterized By Displayed Symbols And Control Method Thereof

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/168,368

(22) Filed: Jul. 7, 2008

Related U.S. Application Data
(60) Provisional application No. 60/985,444, filed on Nov. 5, 2007.

(51) Int. Cl. A63F 13/00

(52) U.S. Cl. 463/21

(57) ABSTRACT

A slot machine includes a display, and a controller. The controller is operable to execute a unit game for rearranging symbols arranged on the display, and in a case where symbols rearranged on a payline on the display is a combination formed by numerical symbols and a currency unit symbol, generate a prize of as much an amount as determined by the numerical symbols and the currency unit symbol.

### CROSS REFERENCE TO RELATED APPLICATIONS

This application claims priority to co-pending U.S. provisional patent application Ser. No. 60/985,444 filed on Nov. 5, 2007, and which is incorporated by reference herein for all purposes.

### BACKGROUND OF THE INVENTION

1. Field of the Invention

The present invention relates to a slot machine in which a rearrangement of a symbol arranged in each of a plurality of partitioned regions that are arranged in a matrix shape formed by a plurality of columns and a plurality of rows is carried out on a display in each unit game, and a playing method thereof.

2. Description of the Related Art

A conventional slot machine is such that, as described in the specification of U.S. Patent Application Publication No. 2002/0025843, for example, in a slot game, when a player inserts arbitrary number of medals into a medal insertion slot and operates a start button, a plurality of symbols are scrolled and then stopped in partitioned regions formed by a plurality of columns and a plurality of rows on a display, and in a case where symbols that constitute a winning combination are stopped on a payline set up in advance or in a case where a prescribed number of scatter symbols are stopped on the payline, a prize according to a number of medals inserted is generated.

In such a conventional slot machine, a payout table indicating a relationship between a winning combination by symbols stopped on the payline and a prize amount or a relationship between a number of scatter symbols stopped in partitioned regions and a prize amount is displayed on a display or the like. Then, the player can recognize the prize amount with respect to the winning combination by symbols stopped on the payline or the prize amount with respect to the scatter symbols stopped in the partitioned regions by referring to this payout table.

In this way, in the conventional slot machine, there are many cases in which the payout amount cannot be recognized intuitively, in a case where the winning combination is realized by symbols stopped on the payline or in a case where a prescribed number of scatter symbols are stopped in the partitioned regions. For this reason, there are demands for an appearance of a slot machine that has a new entertainment quality, in which the prize amount generated as a result of the slot game can be easily recognized intuitively.

The present invention has an object to provide a slot machine and a playing method thereof, which are capable of providing a new entertainment quality in a slot machine in which a rearrangement of symbols arranged in a plurality of partitioned regions which are arranged in a matrix shape formed by a plurality of columns and a plurality of rows is carried out on a display in each unit game.

### SUMMARY OF THE INVENTION

The first aspect of the present invention is a slot machine including: a display configured to display a plurality of symbols, and a controller configured to execute a unit game for rearranging symbols arranged on the display, and generate, in a case where symbols rearranged on a payline on the display is a combination formed by numerical symbols and a currency unit symbol, a prize of as much an amount as determined by the numerical symbols and the currency unit symbol.

The second aspect is a slot machine including: a display configured to display a plurality of symbols, and a controller configured to execute a unit game for rearranging symbols arranged on the display, and generate, in a case where symbols rearranged on a payline on the display is a combination formed by a sequence of numerical symbols and a currency unit symbol on a left end or a right end of the sequence of numerical symbols, a prize of as much an amount as determined by the numerical symbols and the currency unit symbol.

The third aspect is a slot machine including a display configured to display a plurality of symbols, and a controller configured to carry out items described below, (a) executing a unit game for rearranging symbols arranged on the display, (b) making a transition to a second game, in a case where specific symbols are rearranged on a payline on the display or in a case where a prescribed number of specific symbols are rearranged on the display, as a result of executing the unit game, (c) carrying out a rearrangement from an arrangement of a plurality of symbols comprising numerical symbols and a currency unit symbol on the display, in the second game, and (d) generating a prize of as much an amount as determined by a combination of numerical symbols and a currency unit symbol rearranged on the payline.

The fourth aspect is a control method of a slot machine including: a step in which a controller rearranges symbols arranged on a display, and a step in which the controller generates, in a case where symbols rearranged on a payline on the display is a combination formed by numerical symbols and a currency unit symbol, a prize of as much an amount as determined by the numerical symbols and the currency unit symbol.

### BRIEF DESCRIPTION OF THE DRAWINGS

FIG. 1 is an explanatory diagram showing an exemplary display of symbols when a winning combination is realized, which is to be displayed at a slot machine of the present invention.

FIG. 2 is a diagram of an external appearance of a slot machine according to the first to third embodiments of the present invention.

FIG. 3 is a block diagram showing a configuration of a controller of a slot machine according to the first to third embodiments of the present invention.

FIG. 4 is a flow chart showing a slot game execution processing of a slot machine according to the first embodiment of the present invention.

FIG. 5 is a flow chart showing a payline determination processing of a slot machine according to the first embodiment of the present invention.

FIG. 6 is a flow chart showing a symbol scrolling processing of a slot machine according to the first embodiment of the present invention.

FIG. 7 is a flow chart showing a payout processing of a slot machine according to the first embodiment of the present invention.

FIG. 8 is a flow chart showing a payout processing of a slot machine according to a modified example of the first embodiment of the present invention.

FIG. 9 is an explanatory diagram showing an exemplary display at a time of scrolling symbols in a slot machine of the present invention.

FIG. 10 is an explanatory diagram showing an exemplary display of symbols in a slot machine of the present invention.

FIG. 11 is an explanatory diagram showing an exemplary display when a winning combination is not realized, in a slot machine of the present invention.

FIG. 12 is an explanatory diagram showing an exemplary display of symbols in a slot machine of the present invention.

FIG. 13 is an explanatory diagram showing an exemplary display in a case where currency unit symbols are stopped in a left side column of partitioned regions in a slot machine of the present invention.

FIG. 14 is a flow chart showing a slot game execution processing of a slot machine according to the second embodiment of the present invention.

FIG. 15 is a flow chart showing a symbol scrolling processing of a slot machine according to the second embodiment of the present invention.

FIG. 16 is a flow chart showing a second game start processing of a slot machine according to the second embodiment of the present invention.

FIG. 17 is a flow chart showing a second game execution processing of a slot machine according to the second embodiment of the present invention.

FIG. 18 is an explanatory diagram showing an exemplary display of symbols in a slot machine according to the second embodiment of the present invention.

FIG. 19 is an explanatory diagram showing an exemplary display when a winning combination is realized, in a slot machine according to the second embodiment of the present invention.

FIG. 20 is an explanatory diagram showing a payout table to be used in a slot machine according to the second embodiment of the present invention.

FIG. 21 is a network connection diagram of a slot machine according to the third embodiment of the present invention.

FIG. 22 is a block diagram showing a configuration of a game delivery server for delivering a slot game execution program to a slot machine according to the third embodiment of the present invention.

FIG. 23 is a sequence chart showing a procedure of data transmission between a game delivery server and a slot machine according to the third embodiment of the present invention.

FIG. 24 is a diagram of an external appearance of a slot machine according to the fourth embodiment of the present invention.

FIG. 25 is a block diagram showing a configuration of a controller of a slot machine according to the fourth embodiment of the present invention.

FIG. 26A is a diagram of an external appearance of rotation reels to be used in a slot machine according to the fourth embodiment of the present invention, and FIG. 26B is a side view of a rotation reel.

FIG. 27 is an explanatory diagram showing symbols described on circumferential faces of rotation reels to be used in a slot machine according to the fourth embodiment of the present invention.

### DETAILED DESCRIPTION OF THE EMBODIMENTS

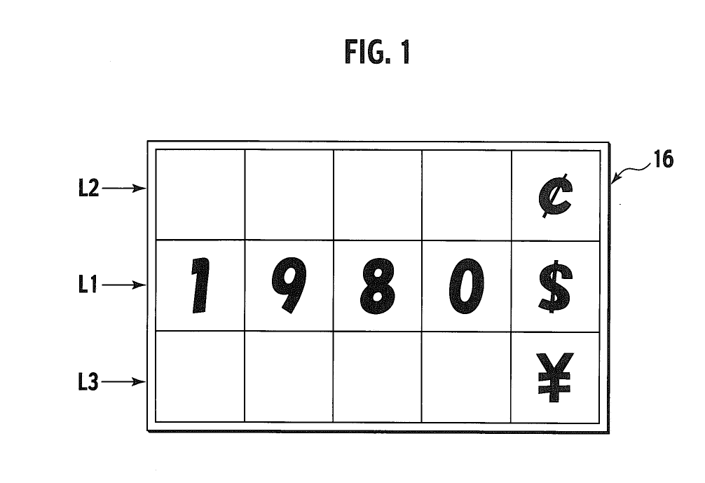

FIG. 1 is an explanatory diagram showing an exemplary display when symbols that constitute a winning combination are stopped and displayed on a liquid crystal display 16 of a slot machine according to the present invention. As shown in FIG. 1, on the liquid crystal display 16, total 15 partitioned regions of three rows by five columns are set up, and when a slot game (unit game) is executed, symbols are scrolled in the 15 partitioned regions, and then, stopped and displayed (a rearrangement from an arrangement of symbols is carried out). Also, according to a number of medals bet, a payline L1 on a center level transverse direction, a payline L2 on an upper level transverse direction, and a payline L3 on a lower level transverse direction are activated, and in a case where a combination of numerical symbols comprising “0” to “9” and a currency unit symbol such as [symbol] , “$” or [symbol] is stopped on the payline L1, for example, a prize of as much an amount as that for these numerical symbols and currency unit symbol is generated.

In an example shown in FIG. 1, symbols of “1”, “9”, “8”, “0” and “$” are stopped on the payline L1, so that a prize as much as “$1,980” will be generated. For this reason, a player can intuitively recognize a prize amount in a case where a winning combination is realized.

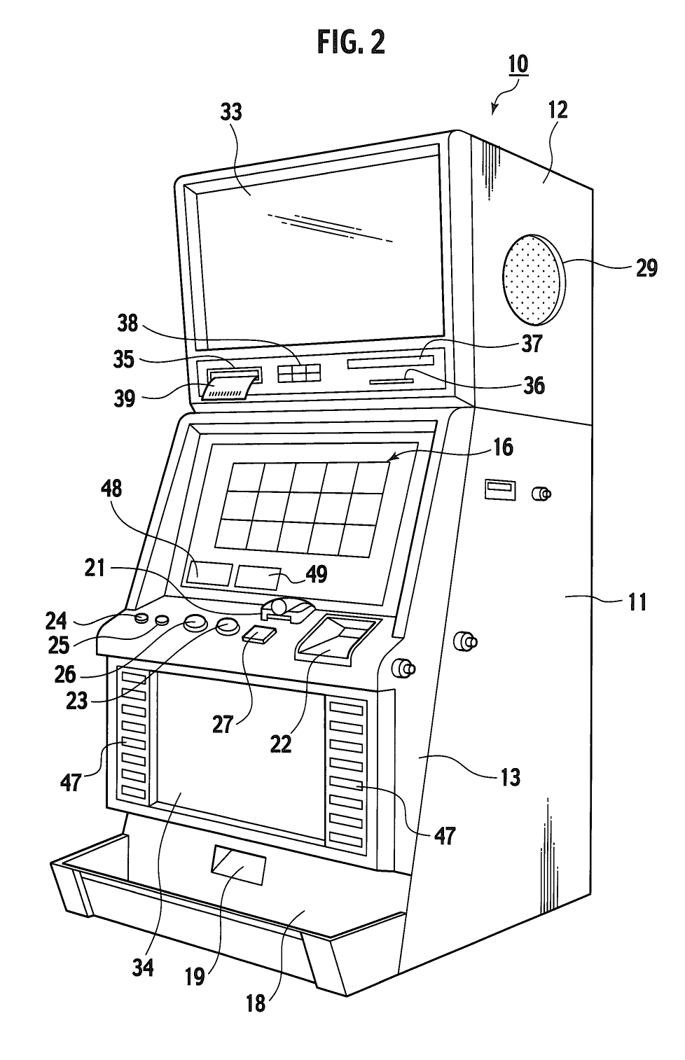

In the following, a configuration of a slot machine 10 according to the first embodiment of the present invention will be described in detail. FIG. 2 is a perspective view showing an outward appearance of the slot machine 10 according to the first embodiment of the present invention.

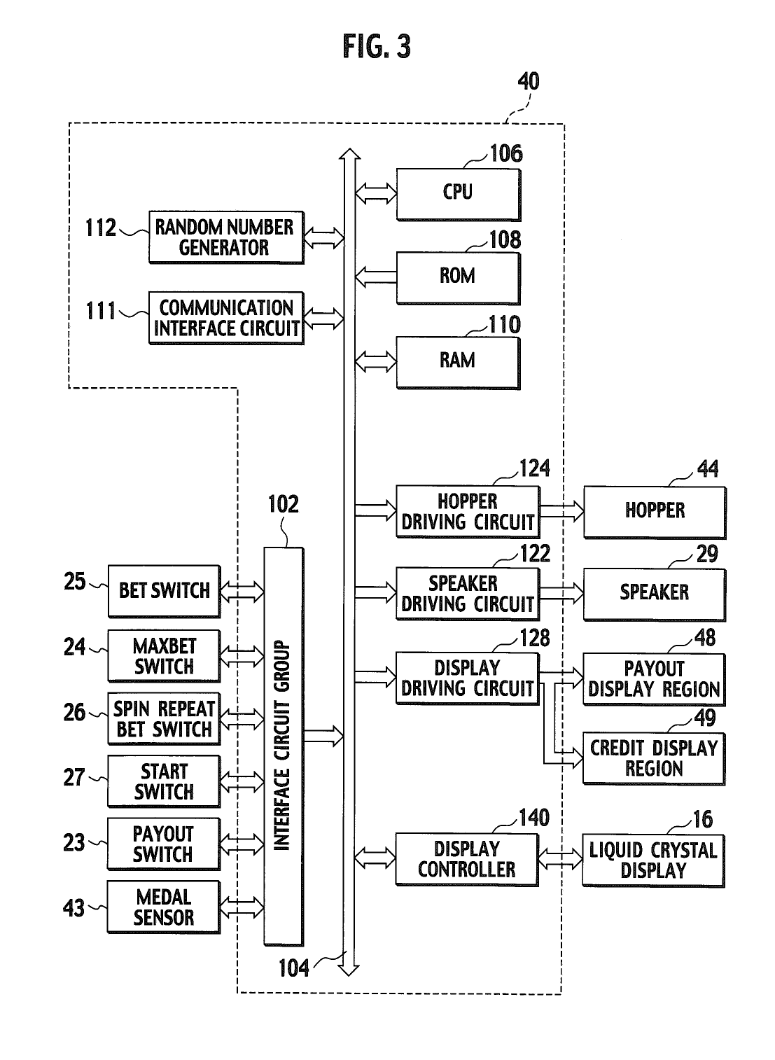

As shown in FIG. 2, the slot machine 10 has a cabinet 11, a top box 12 arranged on an upper side of the cabinet 11, and a main door 13 provided on a front face of the cabinet 11. The cabinet 11 has a liquid crystal display 16 provided on a side facing a player. Also, inside the cabinet 11, various constituent members including a controller 40 (see FIG. 3) for electrically controlling this slot machine 10, a hopper 44 (see FIG. 3) for controlling insertion, deposit and payout of medals, etc., are provided.

Also, in this embodiment, an exemplary case of using medals as the gaming medium to be used at a time of executing a slot game is described, but the gaming medium is not limited to the medals, and can be medals, tokens, electronic money, or electronic value information (credit) corresponding to these, for example.

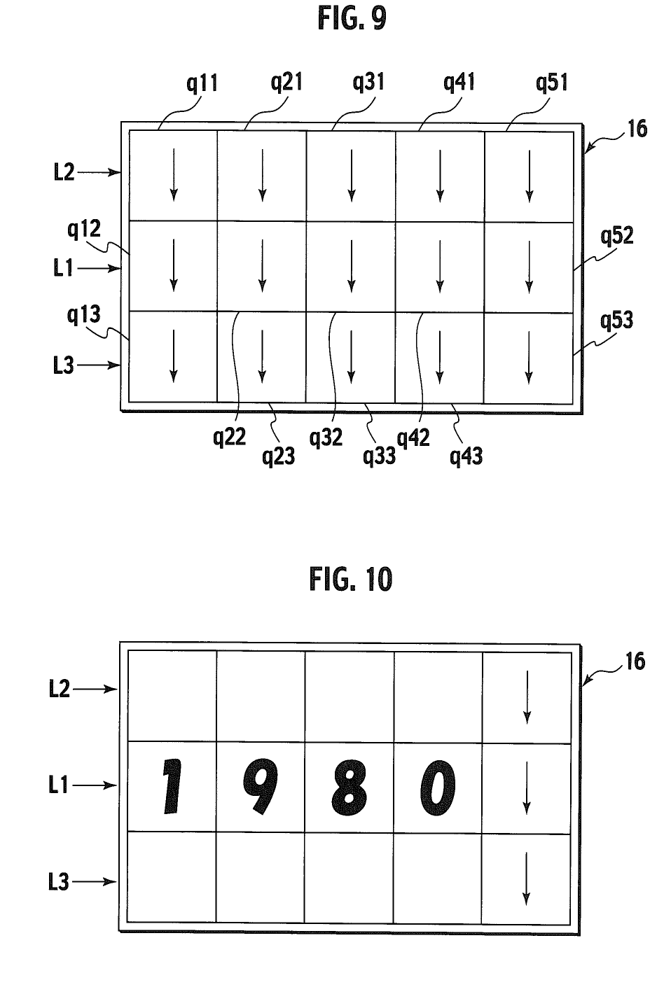

The main door 13 is attached to be capable of being opened or closed with respect to the cabinet 11, and on an approximate center of this main door 13, the liquid crystal display 16 is provided. On the liquid crystal display 16, the total 15 partitioned regions q11 to q53 of three rows by five columns (see FIG. 9) are provided, and various symbols will be displayed in these partitioned regions q11 to q53. Namely, when a slot game is started, a dynamically changing display of symbols displayed in the partitioned regions q11 to q53 is started simultaneously, and stopped simultaneously after a prescribed time has elapsed (a rearrangement from an arrangement is carried out). Then, a prize is generated according to a combination of symbols stopped in the partitioned regions q11 to q53. For example, a prize is generated in a case where a winning combination is realized, by symbols stopped on the paylines L1 to L3. Also, in the second embodiment to be described below, a prize is generated also in a case where a prescribed number of scatter symbols are stopped in the 15 partitioned regions q11 to q53.

Note that, as shown in FIG. 9, the suffix comprising a number of two digits attached to a partitioned region “q” indicates “column” and “row”, so that the partitioned region of the first column and the first row is indicated by “q11”, and the partitioned region of the fifth column and the third row is indicated by “q53”, for example.

Also, on a lower left region of the liquid crystal display 16, a credit display region 49 for displaying a current credit, and a prize amount display region 48 for displaying a prize amount are provided.

On a lower side of the liquid crystal display 16, a medal insertion slot 21 for inserting medals, and a bill validator 22 for checking the validity of bills and accepting valid bills, which are to be used at a time of playing a slot game, are provided. Also, in a vicinity of these medal insertion slot 21 and bill validator 22, various types of operation switches are provided.

As the operation switches, a payout switch 23, a MAXBET (max bet) switch 24, a BET (bet) switch 25, a spin repeat BET (bet) switch 26, and a start switch 27 are provided.

The BET switch 25 is a switch for determining the credit amount to be bet with respect to the slot game to be executed on the liquid crystal display 16, where the credit of one medal will be bet every time the BET switch 25 is pressed, as will be described below.

The spin repeat BET switch 26 is a switch for executing the slot game by betting the credit again without changing the credit amount bet by the BET switch 25 described above in a previous game.

The start switch 27 is a switch for starting the slot game after the desired amount of credit is bet. When this start switch 27 is pressed after either medals are inserted into the medal insertion slot 21 or the credit is bet by the BET switch 25, the slot game will be started on the liquid crystal display 16.

The payout switch 23 is a switch for having the medals of the credit ejected out, and the medals to be paid will be ejected from a medal payout opening 19 that is opening at a lower front side of the main door 13, and the paid medals will be accumulated in a medal tray 18.

The MAXBET switch 24 is a switch for betting the maximum amount of credit (30 medals, for example) that can be bet in one slot game, by a single operation.

On a lower front face of the main door 13, a foot display 34 is provided, which displays various images regarding the slot game. This image can be a character of the slot machine 10 or the like, for example.

On both sides of the foot display 34, lamps 47 are provided, which are lighted up according to a lighting pattern set up in advance for the slot game to be executed at the slot machine 10. On a lower side of the foot display 34, the payout opening 19 from which medals to be paid are ejected, and the medal tray 18 for accumulating the ejected medals are provided.

On a side face of the top box 12, a speaker 29 is provided, and in addition, on a front face of the top box 12, an upper display 33 is provided. The upper display 33 has a liquid crystal panel, which displays various images such as a character regarding the slot game or the like.

On a lower side of the upper display 33, a ticket printer 35, a card reader 36, a data display 37, and a key pad 38 are provided.

The ticket printer 35 prints a bar code, in which data such as the amount paid, the date and time, the identification number of the slot machine 10, etc. are encoded, on a ticket, and outputs it as a bar code attached ticket 39. A player can have the bar code attached ticket 39 read at another slot machine and play a game at this slot machine, or exchange the bar code attached ticket 39 to bills and the like of each currency at a prescribed location in a gaming facility (a cashier in the casino, for example).

The card reader 36 is capable of having a smart card inserted, and carries out a reading of data from the inserted smart card and a writing of data into the smart card. The smart card is a card to be carried around by a player, which stores data for identifying a player, data regarding a log of games played by a player, etc. The smart card may also store data corresponding to coins, bills, or credit. Also, instead of the smart card, a magnetic stripe card may be adopted.

The data display 37 is formed by a fluorescent display or the like, and displays data read by the card reader 36 and data inputted by a player through the key pad 38, for example.

The key pad 38 is for inputting commands and data regarding a ticket issuance and the like.

FIG. 3 is a block diagram showing a controller 40 provided in the slot machine 10 according to this embodiment, and an electric configuration of various devices connected to this controller 40. The controller 40 of the slot machine 10 shown in FIG. 3 is a micro-computer, which has an interface circuit group 102, an input/output bus 104, a CPU 106, a ROM 108, a RAM 110, a communication interface circuit 111, a random number generator 112, a speaker driving circuit 122, a hopper driving circuit 124, a display driving circuit 128, and a display controller 140.

The interface circuit group 102 is connected to the input/output bus 104, and this input/output bus 104 carries out input/output of data signals or address signals with respect to the CPU 106.

To the interface circuit group 102, the start switch 27 is connected. A start signal outputted from this start switch 27 is converted into a prescribed signal at the interface circuit group 102, and then transmitted to the CPU 106 through the input/output bus 104.

In addition, to the interface circuit group 102, the BET switch 25, the MAXBET switch 24, the spin repeat BET switch 26 and the payout switch 23 are connected. Then, the switching signals outputted from these switches 25, 24, 26 and 23 are supplied to the interface circuit group 102, converted into prescribed signals at this interface circuit group 102, and then transmitted to the CPU 106 through the input/output bus 104.

Moreover, to the interface circuit group 102, a medal sensor 43 is connected. The medal sensor 43 is a sensor for detecting medals inserted at the medal insertion slot 21, which is provided at a medal insertion portion of the medal insertion slot 21. A detection signal outputted from this medal sensor 43 is supplied to the interface circuit group 102, converted into a prescribed signal at this interface circuit group 102, and then transmitted to the CPU 106 through the input/output bus 104.

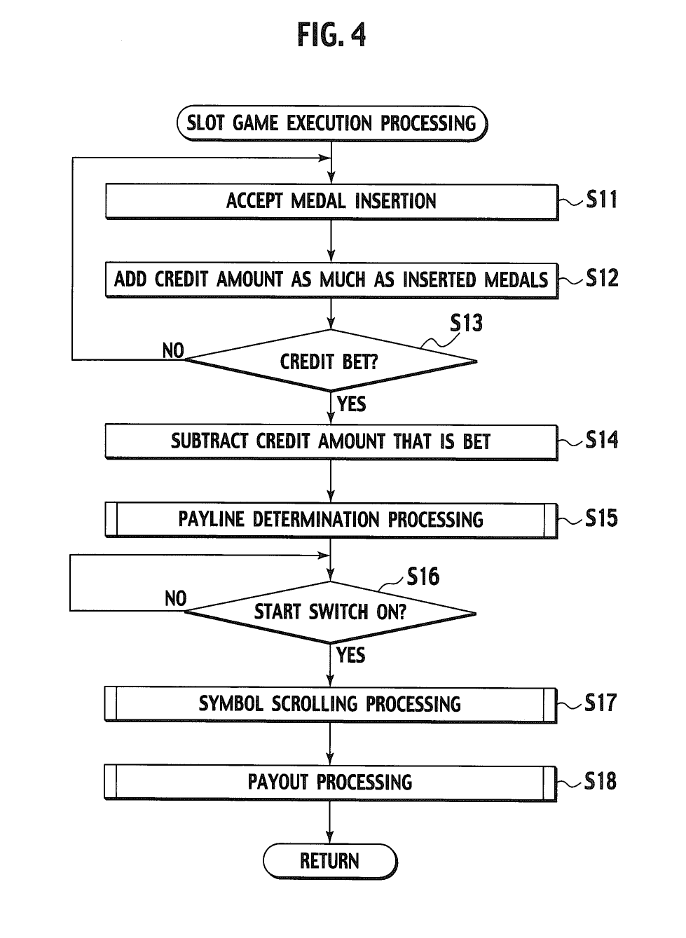

Next, with references to the flow charts shown in FIG. 4 to FIG. 7, the processing procedure of the slot game to be executed at the slot machine 10 according to the first embodiment of the present invention will be described. FIG. 4 is a flow chart showing a slot game execution processing to be executed by the controller 40 of the slot machine 10. This processing is a processing in which the CPU 106 executes a slot game program stored in the ROM 108.

When the slot game execution processing shown in FIG. 4 is started, at the step S11, the CPU 106 starts acceptance of the medal insertion. In this processing, the insertion of medals from the medal insertion slot 21 by the player is accepted, and in a case where the medals are inserted, the number of inserted medals is detected by the medal sensor 43.

At the step S12, the CPU 106 adds the credit amount as much as the number of inserted medals, and displays the credit amount after the addition in the credit display region 49.

At the step S13, the CPU 106 judges whether the credit is BET or not. In this processing, the CPU 106 judges whether or not a signal outputted from the BET switch 25 as the BET switch 25 is pressed, or a signal outputted from the MAXBET switch 24 as the MAXBET switch 24 is pressed, or a signal outputted from the spin repeat BET switch 26 as the spin repeat BET switch 26 is pressed, is received. In a case where it is judged that the credit is not BET, the processing is returned to the step S11.

On the other hand, in a case where it is judged that the credit is BET at the step S13, the CPU 106 proceeds to the step S14, and subtracts the credit amount that is BET. As a result, the credit in which the credit amount that is BET is subtracted will be displayed in the credit display region 49.

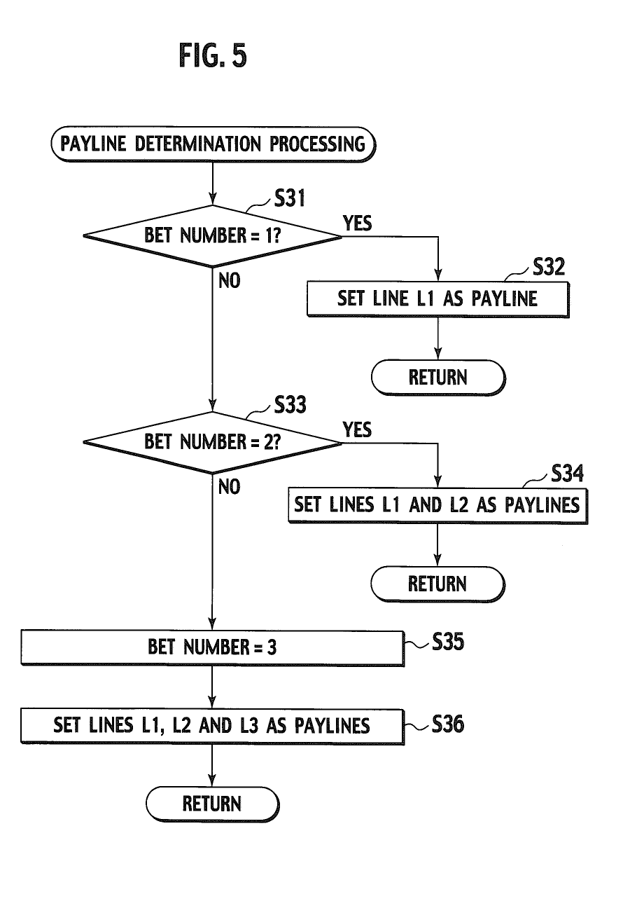

At the step S15, the CPU 106 determines the paylines according to the credit amount that is BET. The detailed explanation of the payline determination processing will be described below with reference to FIG. 5.

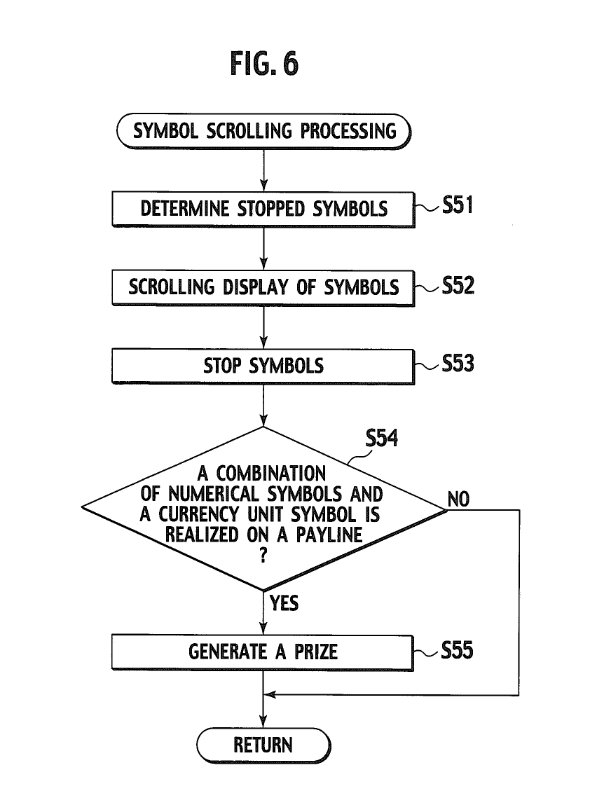

At the step S16, the CPU 106 judges whether the start switch 27 is pressed or not. In this processing, the CPU 106 judges whether or not a signal outputted from the start switch 27 as the start switch 27 is pressed is received. In a case where it is judged that the start switch 27 is pressed, the CPU 106 proceeds to the step S17, and executes the symbol scrolling processing. In this scrolling processing, a processing for changing the symbols displayed in the partitioned regions q11 to q53, stopping them after a prescribed time has elapsed, and displaying new symbols in the partitioned regions q11 to q53 is executed. Then, in a case where symbols (numerical symbols and the currency unit symbols to be described below) that constitute a winning combination are stopped on the payline determined by the processing of the step S15 as a result of the scrolling processing, a prize is generated. The detailed explanation of the scrolling processing will be described below with reference to FIG. 6.

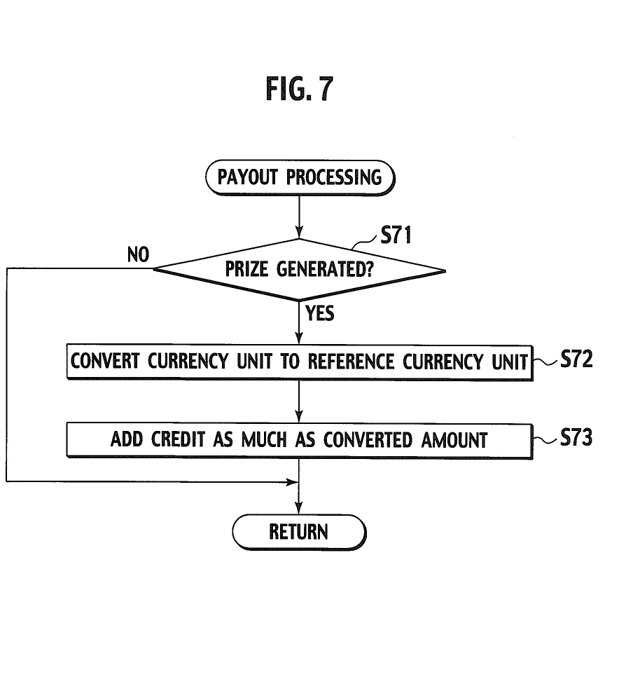

At the step S18, the CPU 106 executes the payout processing. In the payout processing, a payout corresponding to a prize generated as a result of having the winning combination realized by the symbols stopped on the payline is generated. The detailed explanation of the payout processing will be described below with reference to FIG. 7.

In this way, by repeating the processing of the steps S11 to S18, the slot game (unit game) will be executed repeatedly.

Next, the payline determination processing shown in the step S15 of FIG. 4 will be described with reference to the flow chart shown in FIG. 5.

At the step S31, the CPU 106 judges whether the credit amount that is bet is “1” or not. In a case where it is judged that the credit amount that is bet is “1”, the CPU 106 sets the line L1, which is the center level transverse line shown in FIG. 9, as the payline, at the step S32.

At the step S33, the CPU 106 judges whether the credit amount that is bet is “2” or not. In a case where it is judged that the credit amount that is bet is “2”, the CPU 106 sets the line L2, which is the upper level transverse line, as the payline, in addition to the line L1 shown in FIG. 9, at the step S34. In other words, two lines of the lines L1 and L2 are set as the paylines.

At the step S35, the CPU 106 judges that the credit amount that is bet is “3”. Then, the CPU 106 sets the line L3, which is the lower level transverse line, as the payline, in addition to the lines L1 and L2 shown in FIG. 9, at the step S36. In other words, three lines of the lines L1, L2 and L3 are set as the paylines. In this way, the paylines are set according to the credit amount that is bet.

Next, the symbol scrolling processing shown in the step S17 of FIG. 4 will be described with reference to the flow chart shown in FIG. 6.

At the step S51, the CPU 106 carries out the stopped symbol determination processing. In this stopped symbol determination processing, the CPU 106 determines symbols to be stopped and displayed in the partitioned regions q11 to q53 by executing a stopped symbol determination program which is one of the game execution programs stored in the ROM 108. In this processing, the CPU 106 selects a random number from numerical values of “0 to 255” for each of the partitioned regions q11 to q53 by executing a random number generation program, and determines a stopped symbol by referring to a correspondence between a random number and a symbol stored in the ROM 108.

Next, at the step S52, the CPU 106 carries out the symbol scrolling display processing. As a result, as shown in FIG. 9, the scrolling of symbols is started in the partitioned regions q11 to q53. In this processing, the numerical symbols comprising “0” to “9” are scrolled in four columns on the left side (columns of q11, q21, q31 and q41), and the currency unit symbols comprising “$”, [symbol] , [symbol] , etc. are scrolled in one column on the right side (column of q51), among the partitioned regions q11 to q53.

After that, at the step S53, the CPU 106 carries out a processing for stopping symbols. This processing is a processing for stopping symbols scrolled in the partitioned regions q11 to q53. As a result, as shown in FIG. 10 for example, the numerical symbols of “1”, “9”, “8” and “0” are stopped from the left side on the payline L1, and further as shown in FIG. 1, the currency unit symbol of “$” is stopped in the partitioned region q52 at the right edge of the payline L1. Namely, the symbols of “1”, “9”, “8”, “0” and “$” are stopped on the payline L1.

When the symbol stopping processing is finished, the CPU 106 proceeds to the step S54, and judges whether a combination formed by the numerical symbols and a currency unit symbol, that is, a winning combination is realized or not, according to the symbols stopped in the partitioned regions q11 to q53. In this embodiment, it is judged as winning in a case where a combination formed by four numerical symbols and one currency unit symbol is realized on the payline.

Then, in a case where it is judged as winning, such as a case in which “1”, “9”, “8”, “0” and “$” are stopped on the payline L1 as shown in FIG. 1, for example, the CPU 106 shifts the processing to the step S55.

At the step S55, the CPU 106 generates a prize corresponding to the stopped symbols. For example, in a case where a combination of “1”, “9”, “8”, “0” and “$” is realized, a prize of “$1,980” in the currency unit of U.S. “$” is generated.

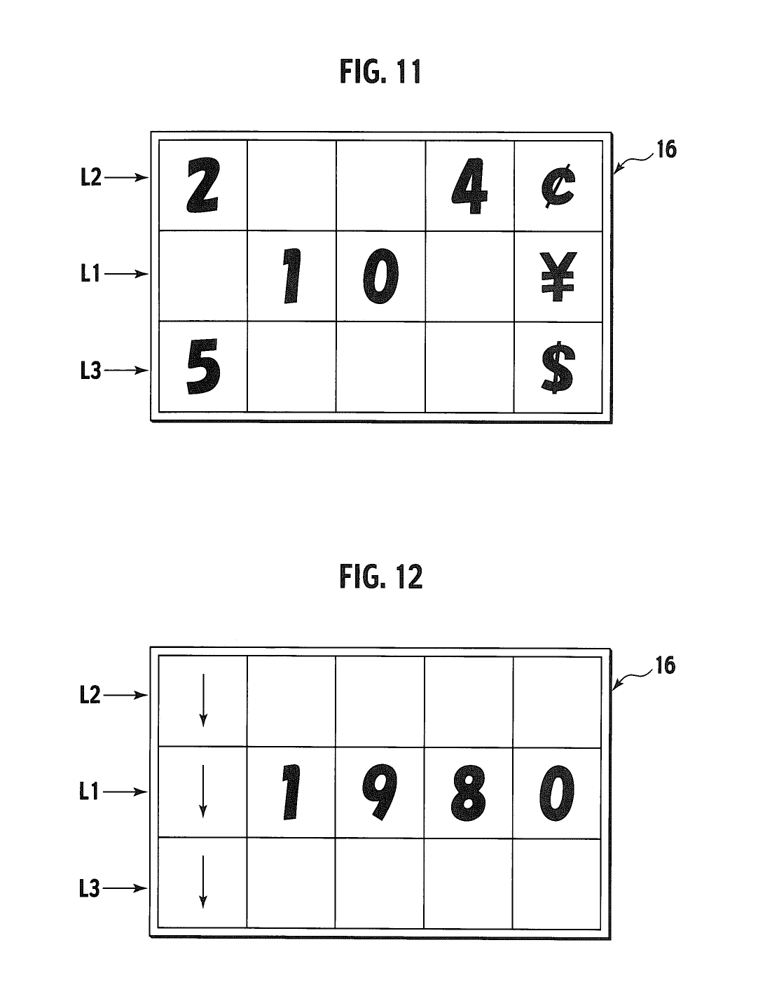

Also, in a case where the symbols are stopped in the partitioned regions q11 to q53 and the CPU 106 judges that a combination formed by the numerical symbols and a currency unit symbol is not realized at that point at the step S54, such as a case where it is judged that a combination formed by four numerical symbols and a currency unit symbol is not realized on any of the paylines L1 to L3 as shown in FIG. 11, for example, the symbol scrolling processing is finished without generating any prize.

Next, the payout processing shown in the step S18 of FIG. 4 will be described with reference to the flow chart shown in FIG. 7.

At the step S71, the CPU 106 judges whether a prize is generated by the processing of the step S55 of FIG. 6 or not. In a case where it is judged that a prize is not generated by the processing of the step S55, the CPU 106 finishes the payout processing without generating any payout.

In a case where it is judged that a prize is generated by the processing of the step S55, the CPU 106 executes a processing for converting the currency unit to the reference currency unit at the step S72. In this processing, in a case where the reference currency unit is set as [symbol] , for example, when a prize of “$1,980” is generated as shown in FIG. 1, the amount in which the currency unit “$” is converted into the currency unit [symbol] is obtained, and the credit according to this amount is calculated. For example, in a case of “$1= [symbol] 120”, the amount converted into the currency unit [symbol] at this rate is obtained.

Here, the reference currency unit can be set in advance by a manager of the slot machine 10, and it is set to agree with the currency unit of the country in which the slot machine 10 is placed, for example. In a case of placing the slot machine 10 in U.S., for example, the reference currency unit is set as “$” which is the currency unit of U.S. Also, in a case of placing the slot machine 10 in Japan, the reference currency unit is set as [symbol] which is the currency unit of Japan.

At the step S73, the CPU 106 adds the credit according to the converted amount. As a result, the credit amount displayed in the credit display region 49 will be increased.

In this way, in the slot machine 10 of the first embodiment, when the slot game is executed, the numerical symbols and the currency unit symbols stopping in the partitioned regions q11 to q53 are scrolled, and then stopped and displayed. Then, in a case where a winning combination formed by four numerical symbols and one currency unit symbol is realized on a payline determined by the payline determination processing, a prize of as much an amount as that indicated by these numerical symbols and currency unit symbol will be generated.

Consequently, the player can intuitively recognize the prize amount, without referring to the payout table or the like which indicates a correspondence between the winning combination and the prize amount, so that the slot game can proceed smoothly.

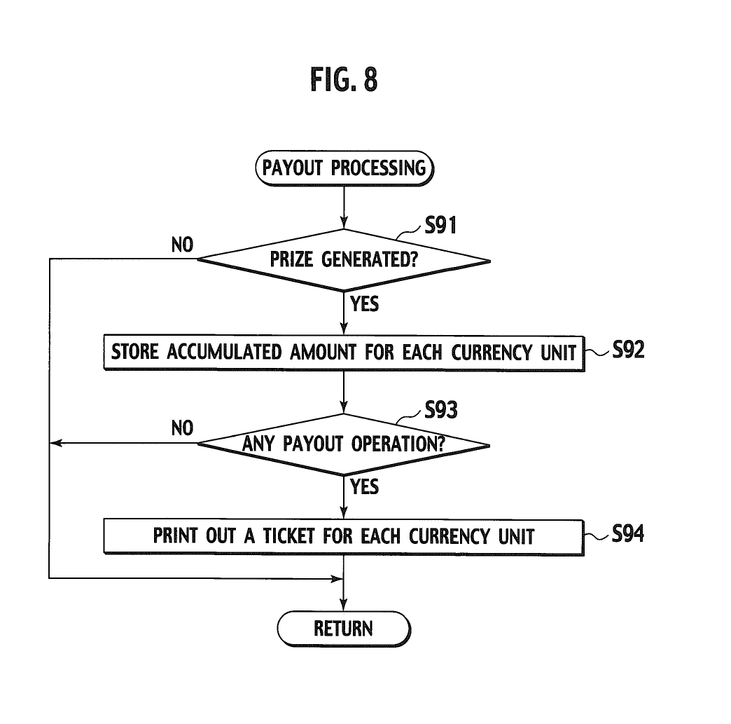

Next, a modified example of the first embodiment will be described. In the first embodiment described above, in a case where the winning combination is realized, the currency unit at that point is converted into the reference currency unit and the credit is added. In contrast, the modified example uses a configuration in which a ticket corresponding to the amount to be paid is issued for each currency unit. In the following, the payout processing according to the modified example of the first embodiment will be described with reference to the flow chart shown in FIG. 8.

At the step S91, the CPU 106 judges whether a prize is generated by the processing of the step S55 of FIG. 6 or not. In a case where it is judged that a prize is not generated by the processing of the step S55, the CPU 106 finishes the payout processing without generating any payout.

In a case where it is judged that a prize is generated by the processing of the step S55, the CPU 106 stores the accumulated amount into the RAM 110 for each currency unit at a time of having a prize generated, at the step S92. In the processing here, in a case where the currency units of the currency unit symbols to be stopped as a result of the slot game are three types of “$”, [symbol] and [symbol] , an accumulated amount memory region for each of these currency units is set up in the RAM 110, and a processing for adding an amount corresponding to a newly generated prize to the amount stored in the accumulated amount memory region is executed whenever a prize is generated.

For example, in a case where a prize of “$1,980” is generated as shown in FIG. 1, “$1,980” will be accumulatively added to the accumulated amount memory region for “$”.

At the step S93, the CPU 106 judges whether the payout operation is generated or not. In this processing, the CPU 106 judges whether the payout switch 23 is pressed or not, and shifts the processing to the step S94 in a case where it is judged that the payout switch 23 is pressed.

At the step S94, the CPU 106 prints out a bar code attached ticket 39 in which the accumulated amount stored for each currency unit is written. By this processing, the bar code attached ticket 39 will be printed out from the ticket printer 35. The player can exchange this bar code attached ticket 39 with bills or the like at the cashier in the casino or the like. At this point, the current rates of the currency units are displayed at the cashier, so that the player can recognize the exchange rate of each currency.

In this way, in the slot machine according to the modified example of the first embodiment, the bar code attached ticket 39 in which data of the payout amount for each currency unit is written is issued, and the player will acquire bills of the amount corresponding to the payout amount in each currency.

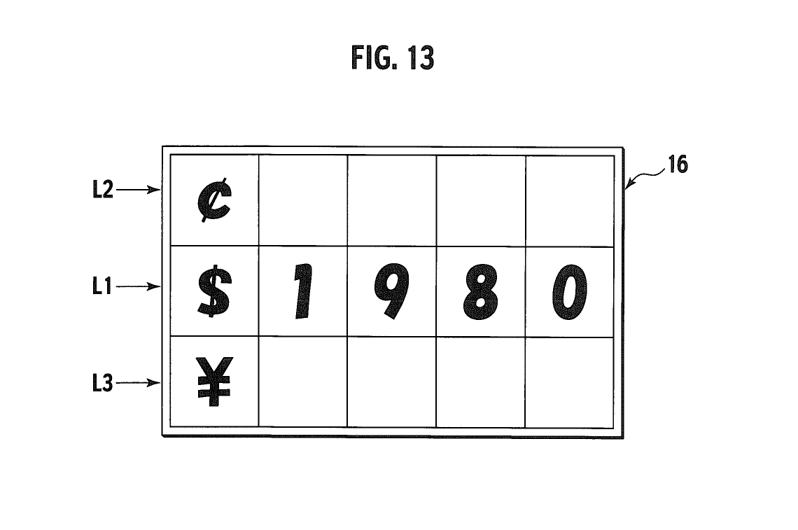

Here, the first embodiment described above uses a configuration in which the numerical symbols are scrolled in four columns on the left side and the currency unit symbols are scrolled in one column on the right side, but it is also possible to use a configuration in which the numerical symbols are scrolled in four columns on the right side and the currency unit symbols are scrolled in one column on the left side. For example, it may be made such that after the scrolling of the numerical symbols and the currency unit symbols is started in the partitioned regions q11 to q53 as shown in FIG. 9, the numerical symbols are stopped and displayed in four columns on the right side as shown in FIG. 12, and after that, the currency unit symbols are stopped in one column on the left side as shown in FIG. 13.

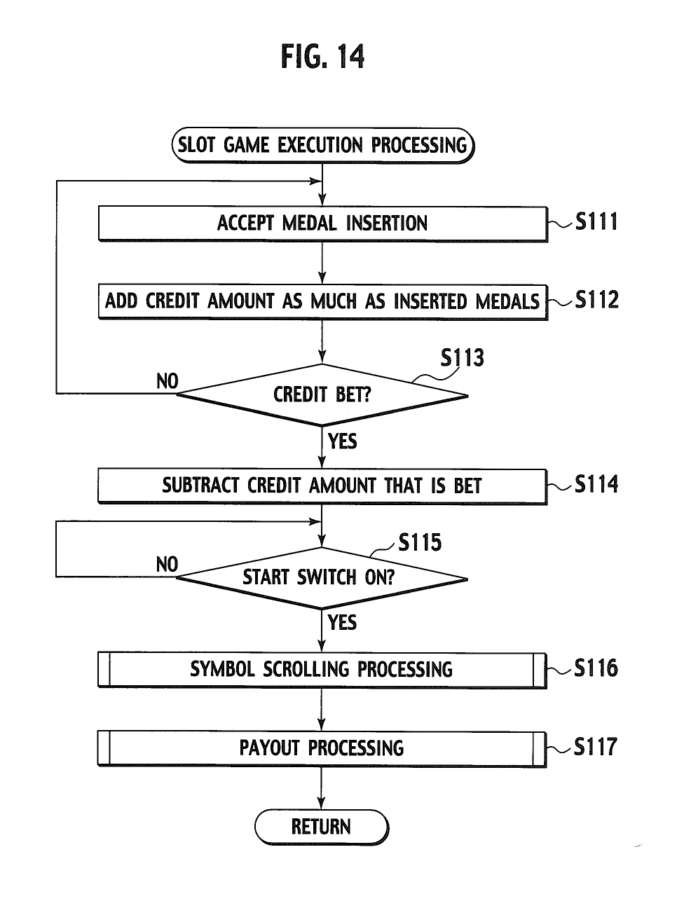

Next, the slot machine 10 according to the second embodiment of the present invention will be described. FIG. 14 is a flow chart showing a slot game execution processing to be executed by the slot machine 10 according to the second embodiment.

When the slot game execution processing shown in FIG. 14 is started, at the step Sill, the CPU 106 starts acceptance of the medal insertion. In this processing, the insertion of medals from the medal insertion slot 21 by the player is accepted, and in a case where the medals are inserted, the number of inserted medals is detected by the medal sensor 43.

At the step S112, the CPU 106 adds the credit as much as the number of inserted medals, and displays the credit amount after the addition in the credit display region 49.

At the step S113, the CPU 106 judges whether the credit is BET or not. In this processing, the CPU 106 judges whether or not a signal outputted from the BET switch 25 as the BET switch 25 is pressed, or a signal outputted from the MAXBET switch 24 as the MAXBET switch 24 is pressed, or a signal outputted from the spin repeat BET switch 26 as the spin repeat BET switch 26 is pressed, is received. In a case where it is judged that the credit is not BET, the processing is returned to the step S111.

On the other hand, in a case where it is judged that the credit is BET at the step S113, the CPU 106 proceeds to the step S114, and subtracts the credit amount that is BET.

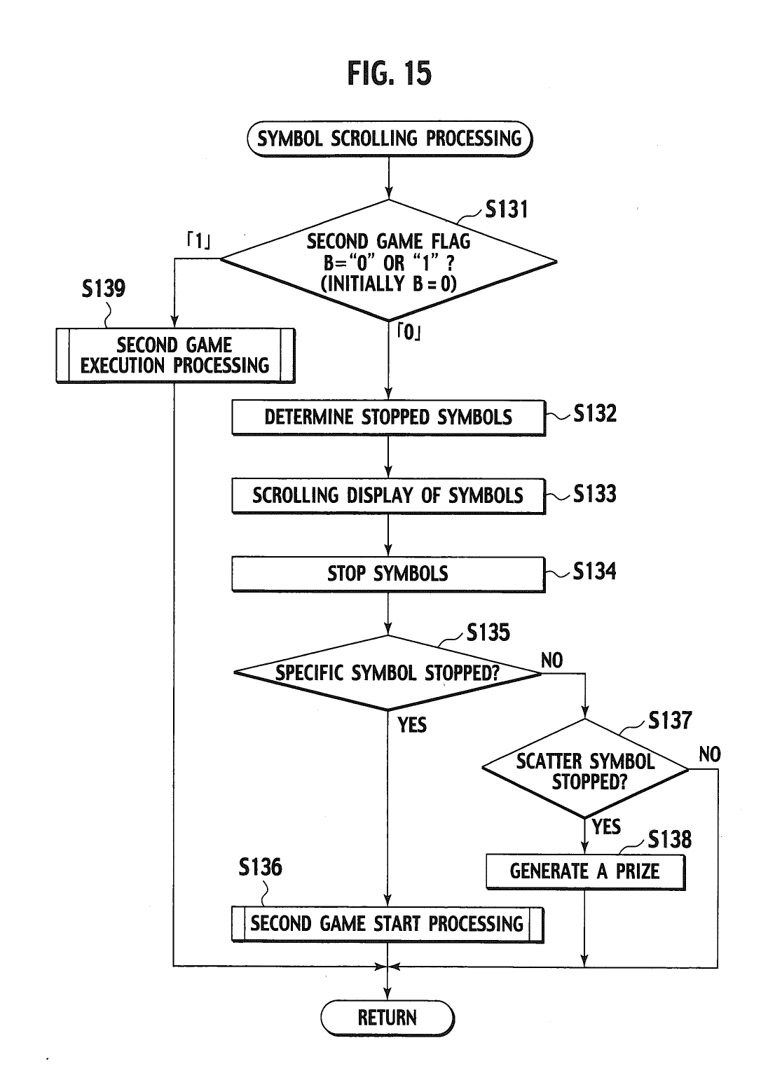

At the step S115, the CPU 106 judges whether the start switch 27 is pressed or not. In this processing, the CPU 106 judges whether or not a signal outputted from the start switch 27 as the start switch 27 is pressed is received. In a case where it is judged that the start switch 27 is pressed, the CPU 106 proceeds to the step S116, and executes the symbol scrolling processing. In this scrolling processing, a processing for changing the symbols displayed in the partitioned regions q11 to q53, stopping them after a prescribed time has elapsed, and displaying new symbols in the partitioned regions q11 to q53 is executed. Then, in a case where symbols that constitute a winning combination are stopped on the payline set up in advance as a result of the scrolling processing, or in a case where a prescribed number of scatter symbols are stopped and displayed in the partitioned regions q11 to q53, a prize is generated. The detailed explanation of the scrolling processing will be described below with reference to FIG. 15.

At the step S117, the CPU 106 executes the payout processing. In the payout processing, a payout corresponding to a prize generated as a result of having the winning combination realized by the symbols stopped on the payline or a prize generated as a result of having a prescribed number of scatter symbols stopped in the partitioned regions q11 to q53 is generated. The detail of the payout processing is similar to the processing shown in FIG. 7 or FIG. 8.

In this way, in the second embodiment, by repeating the processing of the steps S111 to S117, the slot game (unit game) will be executed repeatedly.

Next, the symbol scrolling processing shown in the step S116 of FIG. 14 will be described with reference to the flow chart shown in FIG. 15. At the step S131, the CPU 106 judges whether a second game flag B is “0” or “1”. Initially, it is set that “B=0”, so that the CPU 106 shifts the processing to the step S132.

At the step S132, CPU 106 carries out the stopped symbol determination processing. In this stopped symbol determination processing, the CPU 106 determines symbols to be stopped and displayed in the partitioned regions q11 to q53 by executing a stopped symbol determination program which is one of the game execution programs stored in the ROM 108. In this processing, the CPU 106 selects a random number from numerical values of “0 to 255” for each of the partitioned regions q11 to q53 by executing a random number generation program, and determines a stopped symbol by referring to a correspondence between a random number and a symbol stored in the ROM 108.

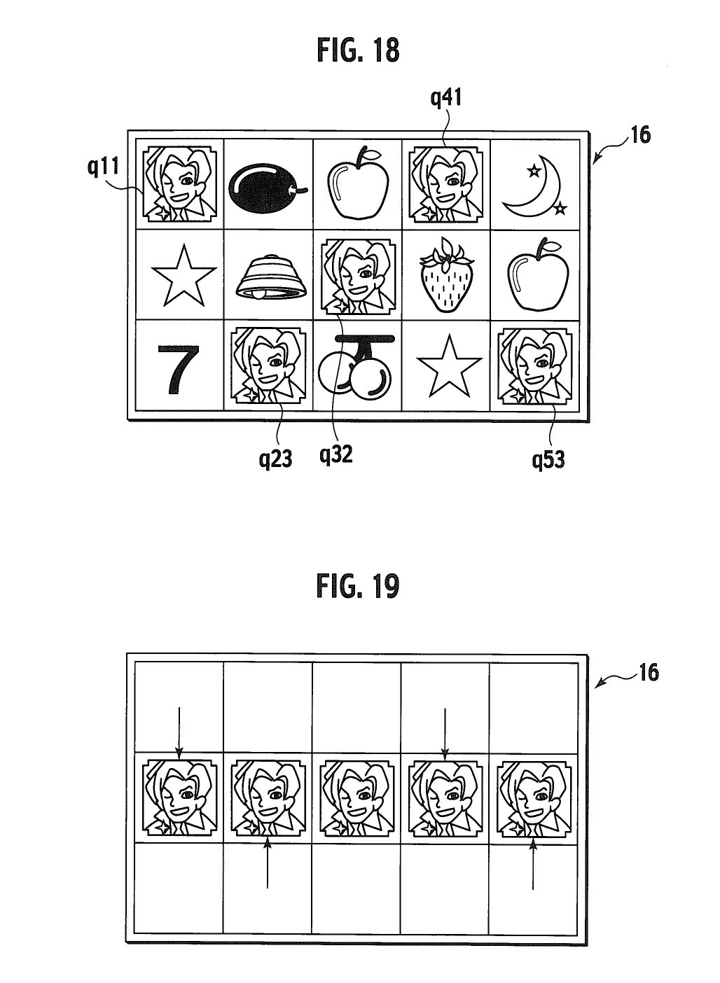

Next, at the step S133, the CPU 106 carries out the symbol scrolling display processing. As a result, as shown in FIG. 9, the scrolling of symbols is started in the partitioned regions q11 to q53. In this processing, a plurality of symbols such as “BELL”, “APPLE”, “PLUM”, “STRAWBERRY”, “CHERRY”, “STAR” and “specific symbol” are scrolled in the partitioned regions q11 to q53, as shown in FIG. 18.

After that, at the step S134, the CPU 106 carries out a processing for stopping symbols. This processing is a processing for stopping symbols scrolled in the partitioned regions q11 to q53. As a result, as shown in FIG. 18 for example, various types of symbols are randomly stopped and displayed in the partitioned regions q11 to q53. In an example shown in FIG. 18, the specific symbols are stopped and displayed in five partitioned regions q11, q23, q32, q41 and q53.

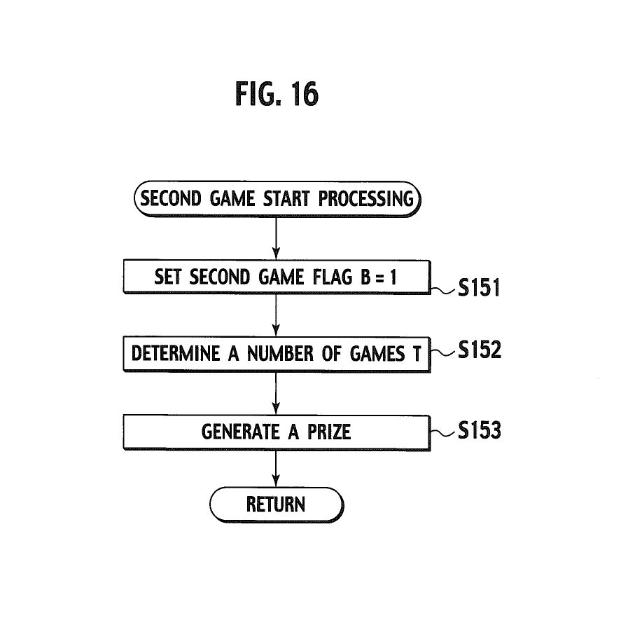

At the step s135, the CPU 106 judges whether a combination of the specific symbols is stopped and displayed in the partitioned regions q11 to q53 or not. Then, in a case where the “specific symbol” is stopped and displayed in each column of the partitioned regions q11 to q53, that is, in a case where the specific symbols are stopped and displayed in five partitioned regions q11, q23, q32, q41 and q53, as shown in FIG. 18, these specific symbols are displayed with emphasis, and the player is made to recognize the fact that a combination of the specific symbols is stopped and displayed as the specific symbols are aligned on a transversal line at the center level, as shown in FIG. 19. After that, at the step S136, the CPU 106 executes the second game start processing. The detail of the second game start processing will be described below with reference to FIG. 16.

On the other hand, in a case where the CPU 106 judged that a combination of the specific symbols is not realized at the processing of the step S135, the processing is shifted to the step S137. At the step S137, the CPU 106 judges whether a prescribed number or more of the scatter symbols are stopped and displayed in the partitioned regions q11 to q53 or not. Then, in a case where the CPU 106 judged that a prescribed number or more of the scatter symbols are stopped and displayed, the processing is shifted to the step S138, and a prize according to the number of the scatter symbols that are stopped and displayed is generated.

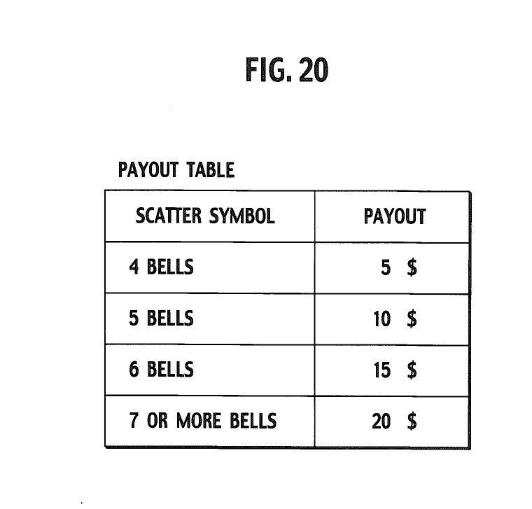

Here, “BELL” is set as the scatter symbol, for example, and the CPU 106 generates a prize according to a payout table shown in FIG. 20. Namely, a prize equivalent to “$5” is generated in a case where four BELLs are stopped and displayed, a prize equivalent to “$10” is generated in a case where five BELLs are stopped and displayed, a prize equivalent to “$15” is generated in a case where six BELLs are stopped and displayed, and a prize equivalent to “$20” is generated in a case where seven or more BELLs are stopped and displayed,

Next, a detailed processing procedure of the second game start processing shown in the step S136 of FIG. 15 will be described with reference to the flow chart shown in FIG. 16.

At the step S151, the CPU 106 sets the second game flag B to “1”, and stores it in the RAM 110. After that, at the step S152, the CPU 106 determines a number of games T for the second game. Here, the “number of games T” is a number of times for the slot game to be executed without betting the credit, which is set to T=25, 50, 100, etc., for example. This number of games T is stored in the RAM 110.

At the step S153, the CPU 106 generates a prize with respect to the fact that a combination of the specific symbols is realized. In this way, the second game start processing is carried out.

Then, when the second game flag B is set to “B=1” at the step S151 of the second game start processing shown in FIG. 16, it becomes “B=1” at the processing of the step S131 of FIG. 15, and the CPU 106 carries out the second game execution processing at the step S139.

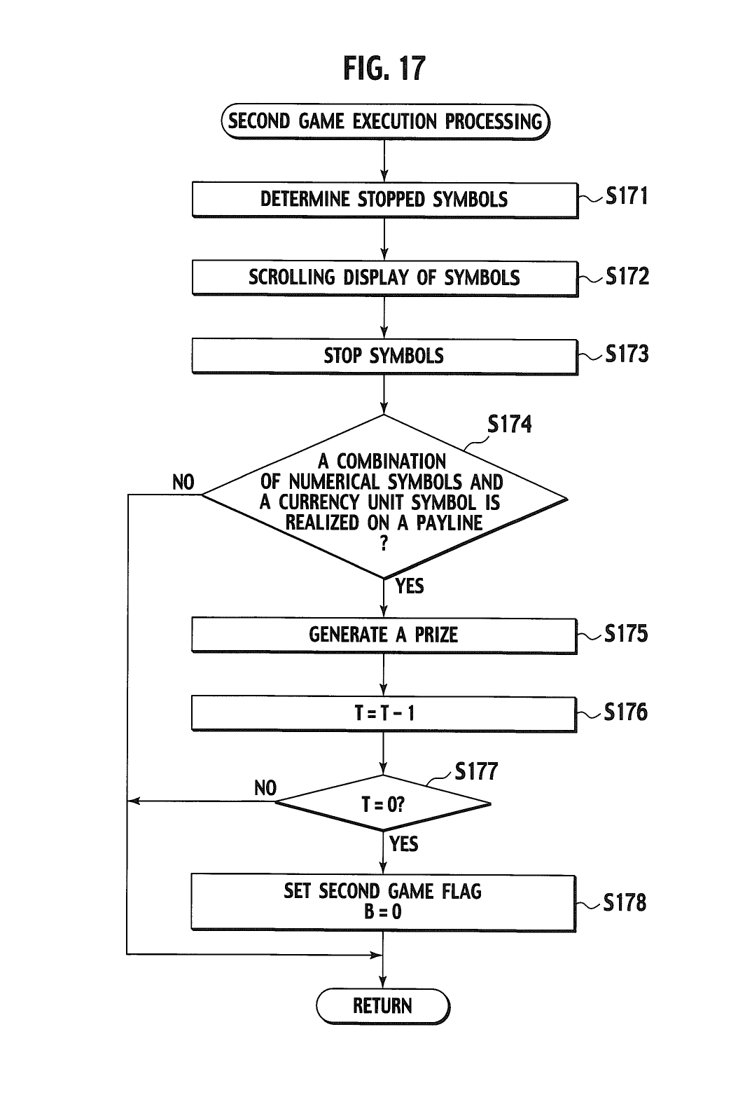

In the following, a detailed processing procedure of the second game execution processing will be described with reference to the flow chart shown in FIG. 17. When the second game execution processing is started, the CPU 106 carries out the stopped symbol determination processing at the step S171.

Next, at the step S172, the CPU 106 carries out the symbol scrolling display processing. As a result, as shown in FIG. 9, the scrolling of symbols is started in the partitioned regions q11 to q53. In this processing, the numerical symbols comprising “0” to “9” are scrolled in four columns on the left side, and the currency unit symbols such as “$”, [symbol] and [symbol] are scrolled in one column on the right side, among the partitioned regions q11 to q53, as shown in FIG. 1.

After that, at the step S173, the CPU 106 carries out a processing for stopping symbols. This processing is a processing for stopping symbols scrolled in the partitioned regions q11 to q53.

At the step S174, the CPU 106 judges whether a combination of the numerical symbols and a currency unit symbol is stopped on the payline L1 (center level transverse line) or not. As a result, in a case where symbols of “1”, “9”, “8”, “0” and “$” are stopped and displayed on the payline L1 as shown in FIG. 1, for example, it is shifted to the step S175, and the CPU 106 generates a prize of an amount according to the numerical symbols and the currency unit symbol that are stopped and displayed. The prizes generated by this processing will be paid by either one processing among the payout processing shown in FIG. 7 and the payout processing shown in FIG. 8.

At the step S176, the CPU 106 executes a processing for setting the number of games T to “T−1”. In this processing, the CPU 106 sets the number of games Y stored in the RAM 110 to “T−1”.

At the step S177, the CPU 106 judges whether the number of games T stored in the RAM 110 is “T=0” or not, and in a case where it is “T=0”, that is, in a case where the prescribed number of games Y set for the second game is all executed, the second game flag B is set to “B=0”.

Also, in a case where the CPU 106 judged that a combination of the numerical symbols and the currency unit symbol is not stopped on the payline L1 at the processing of the step S174, this second game is finished without generating a prize. For example, in a case where a combination of the numerical symbols and the currency unit symbol is not realized as shown in FIG. 11, a prize will not be generated. In this way, the second game will be carried out.

As such, in the slot machine 10 according to the second embodiment of the present invention, in a case where a combination by the specific symbols is realized by the execution of the slot game, it is shifted to the second game, and the scrolling display and the stopping display using the numerical symbols and the currency unit symbols will be executed for a plurality of times in that second game.

Then, in the second game, the prize amount is determined according to the numerical symbols and the currency unit symbol that are stopped and displayed in the partitioned regions q11 to q53. For this reason, in a case where the second game is executed, the player can intuitively recognize the prize amount, without referring to the payout table or the like which indicates a correspondence between the winning combination and the prize amount, so that the slot game can proceed smoothly.

Next, the slot machine 10 according to the third embodiment of the present invention will be described. In the third embodiment, different types of the slot games will be executed using the same slot machine 10, by rewriting the slot game execution program stored in the ROM 108 to another slot game execution program.

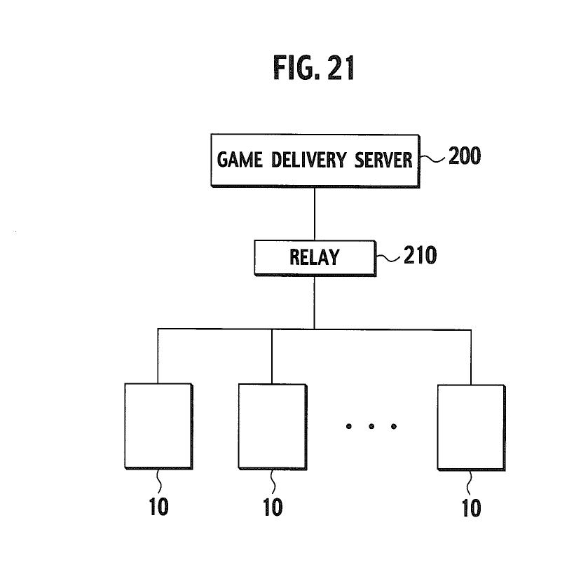

As shown in FIG. 21, a plurality of slot machines 10 are connected to a game delivery server 200 via a relay 210, and each slot machine 10 is made to be capable of executing different types of the slot games by downloading the slot game execution programs delivered from the game delivery server 200 and writing them into the ROM 108.

The controller provided inside each slot machine 10 shown in FIG. 21 and various devices connected to the controller are similar to a configuration shown in FIG. 3, and are connected to the relay 210 and the game delivery server 200 shown in FIG. 21 through the communication interface circuit 111 shown in FIG. 3.

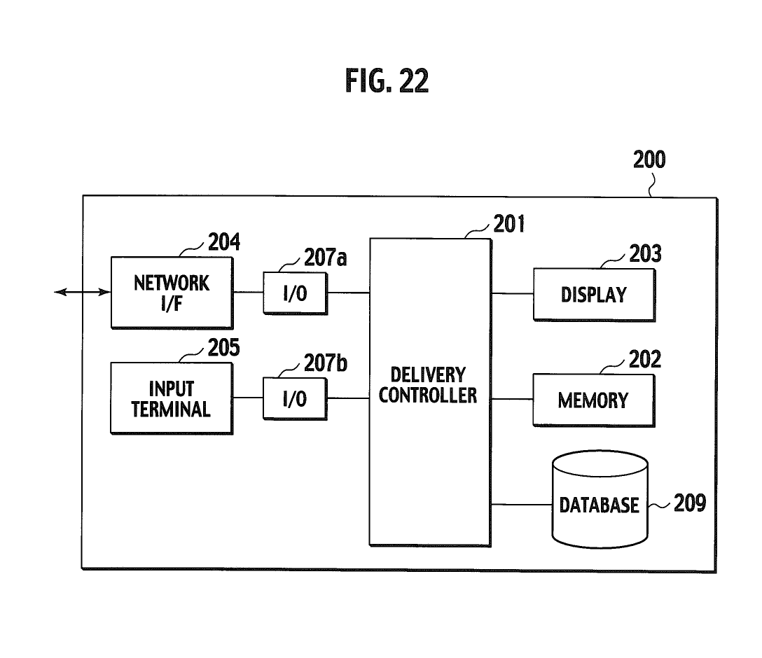

FIG. 22 is a block diagram showing an electric configuration of the game delivery server 200. As shown in FIG. 22, the game delivery server 200 has a delivery controller 201. To the delivery controller 201, a memory 202, a database 209, and a display 203 are connected.

In the database 209, plural types of the slot game execution programs that can be delivered from the game delivery server 200 to each slot machine 10 are stored. Also, to the delivery controller 201, input/output ports 207a and 207b are connected, and among them, the input/output port 207a is connected to a network interface 204 and the input/output port 207b is connected to an input terminal 205. The game delivery server 200 can communicate with each slot machine 10 shown in FIG. 21 through the network interface 204.

A manager of the game delivery server 200 inputs a list of the slot games that can be downloaded to each slot machine 10, by using the input terminal 205. The input terminal 205 may be any of a keyboard, a mouse, a track ball, and other operation switches. Also, the network interface 204 may be either one of a wired network interface and a radio network interface, or may be one that contains both.

The game delivery server 200 has a firewall (not shown in the figure), and unauthorized accesses to programs in the game delivery server 200 are blocked by that firewall.

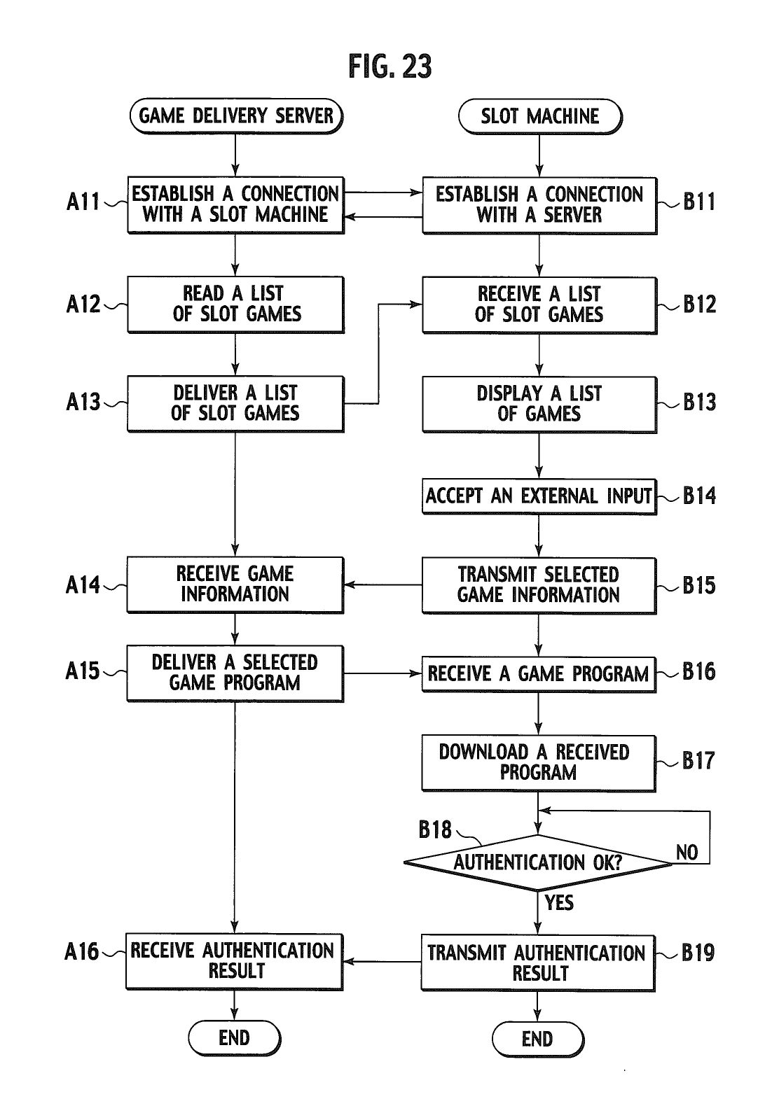

Next, a processing procedure at a time of downloading the slot game execution program delivered from the game delivery server 200 to the slot machine 10 will be described with reference to the sequence chart shown in FIG. 23.

First, the slot machine 10 outputs a connection request with respect to the game delivery server 200, and the game delivery server 200 carries out an authentication check according to this connection request, and establishes a connection between the slot machine 10 and the game delivery server 200 (A11, B11).

The game delivery server 200 reads a list of a plurality of the slot games stored in the database 209 (A12), and displays it on the display 203 while delivering this list of slot games to the slot machine 10 (A13).

The slot machine 10 receives the list of slot games delivered from the game delivery server 200 (B12), and displays the received list of slot games on the liquid crystal display 16 or the like. Then, the slot machine 10 accepts an external input, and selects only one slot game from the list of a plurality of slot games (B14).

After that, the slot machine 10 transmits information on the selected slot game to the game delivery server 200 (B15), and the game delivery server 200 receives the information of this slot game (A14).

The game delivery server 200 recognizes the selected slot game, and delivers this slot game execution program to the slot machine 10 (A15). The slot machine 10 receives the slot game execution program delivered from the game delivery server 200 (B16), and downloads the received slot game execution program to the ROM 108 (B17).

After that, the slot machine 10 carries out an authentication as to whether the downloaded slot game execution program is altered or not (B18), and in a case where the authenticity is checked, transmits an authentication result to the game delivery server 200 (B19) The game delivery server 200 receives the authentication result transmitted from the slot machine 10 (A16). In this way, various types of the slot game execution programs stored in the game delivery server 200 can be downloaded to the slot machine 10, and the slot machine 10 can execute a plurality of types of the slot games. The slot machine 10 will execute the slot game by the method similar to the first embodiment or the second embodiment described above.

In this way, the slot machine 10 according to the third embodiment can execute the slot game by downloading the slot game execution program delivered from the game delivery server 200, so that it is possible to execute a plurality of types of the slot games at a single slot machine 10. Also, as in the first embodiment and the second embodiment described above, the slot machine 10 determines a winning combination by a combination of the numerical symbols of “0” to “9” and the currency unit symbols such as “$”, [symbol] and [symbol] , so that even in a case where a new slot game execution program is downloaded, there is no need to separately display the payout table.

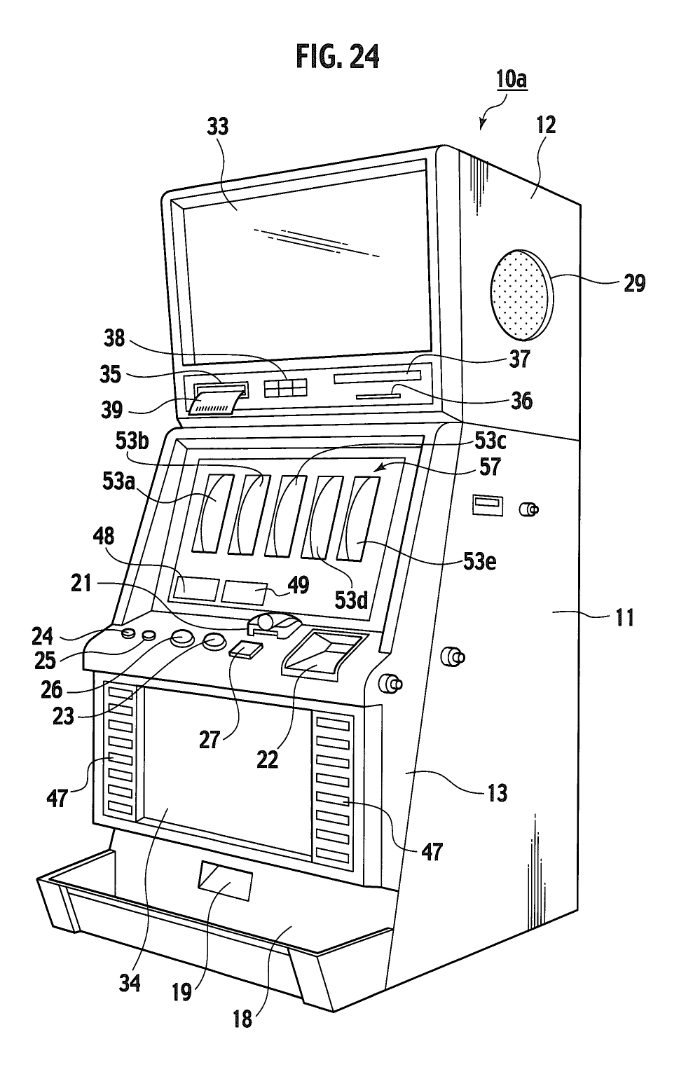

Next, the forth embodiment of the present invention will be described. FIG. 24 is a perspective view showing a configuration of the slot machine 10a according to the fourth embodiment. In contrast to the slot machine 10 shown in FIG. 2, the slot machine 10a shown in FIG. 24 differs in that the slot game is executed by using five rotation reels 53a to 53e.

As shown in FIG. 24, on a back side of the main door 13, five rotation reels 53a to 53e are provided, and the rotation reels 53a to 53e are made visible through display windows 57 formed at approximately central parts of the main door 13.

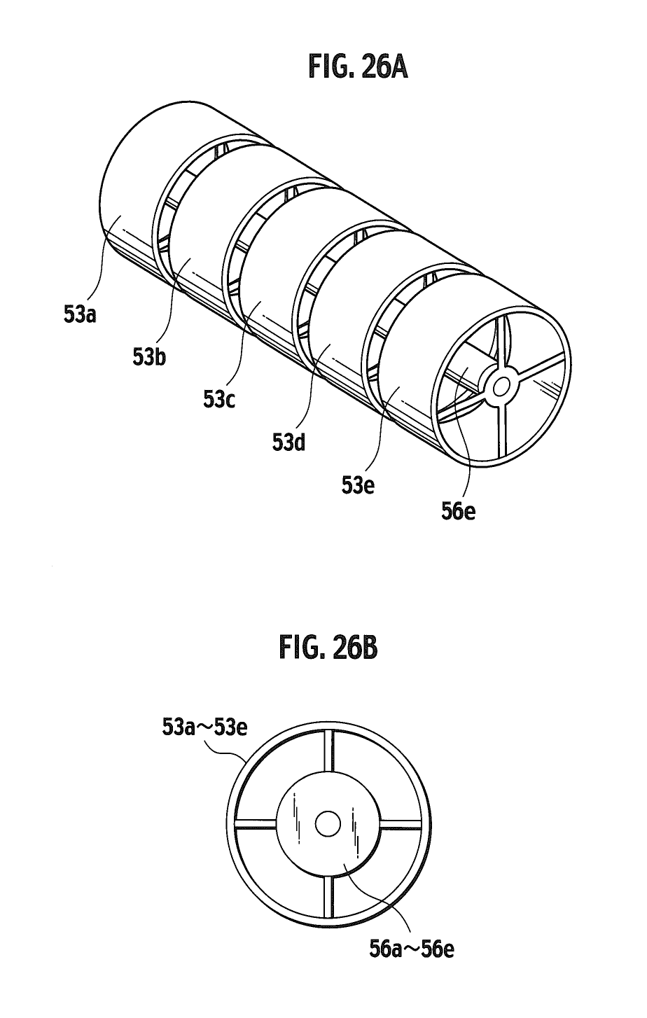

FIG. 26A shows a perspective view of the rotation reels 53a to 53e and FIG. 26B shows a side view of the rotation reels 53a to 53e, and to the rotation reels 53a to 53e, pulse motors 56a to 56e are connected, to drive them into rotation independently.

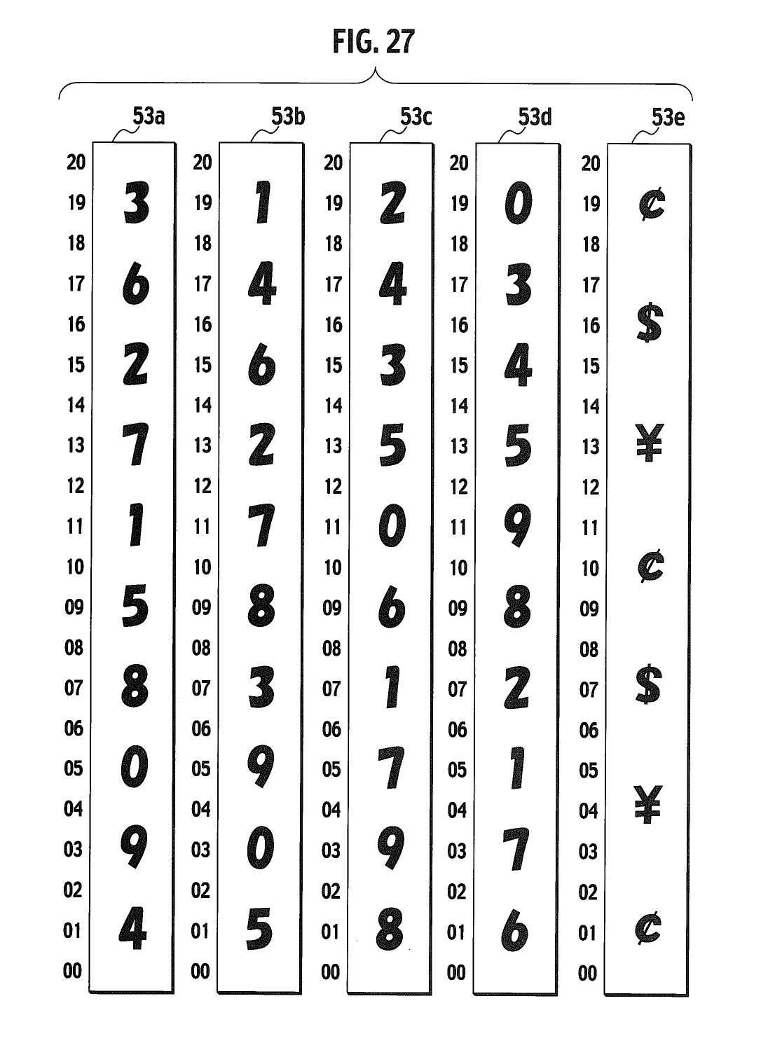

FIG. 27 is an explanatory diagram showing arrays of the numerical symbols and the currency unit symbols which are written on the circumferential faces of the rotation reels 53a to 53e. As shown in FIG. 27, the numerical symbols of “0” to “9” are written randomly, with an interval of one space left open, on the circumferential faces of the rotation reels 53a to 53d which become four columns on the left side. Also, the currency unit symbols of $”, [symbol] and [symbol] are written with an interval, on the rotation reel 53e which becomes one column on the right side. Then, in a case where symbols at a time of start rotating and stopping these rotation reels 53a to 53e become a combination of the numerical symbols and the currency unit symbol, a prize is generated.

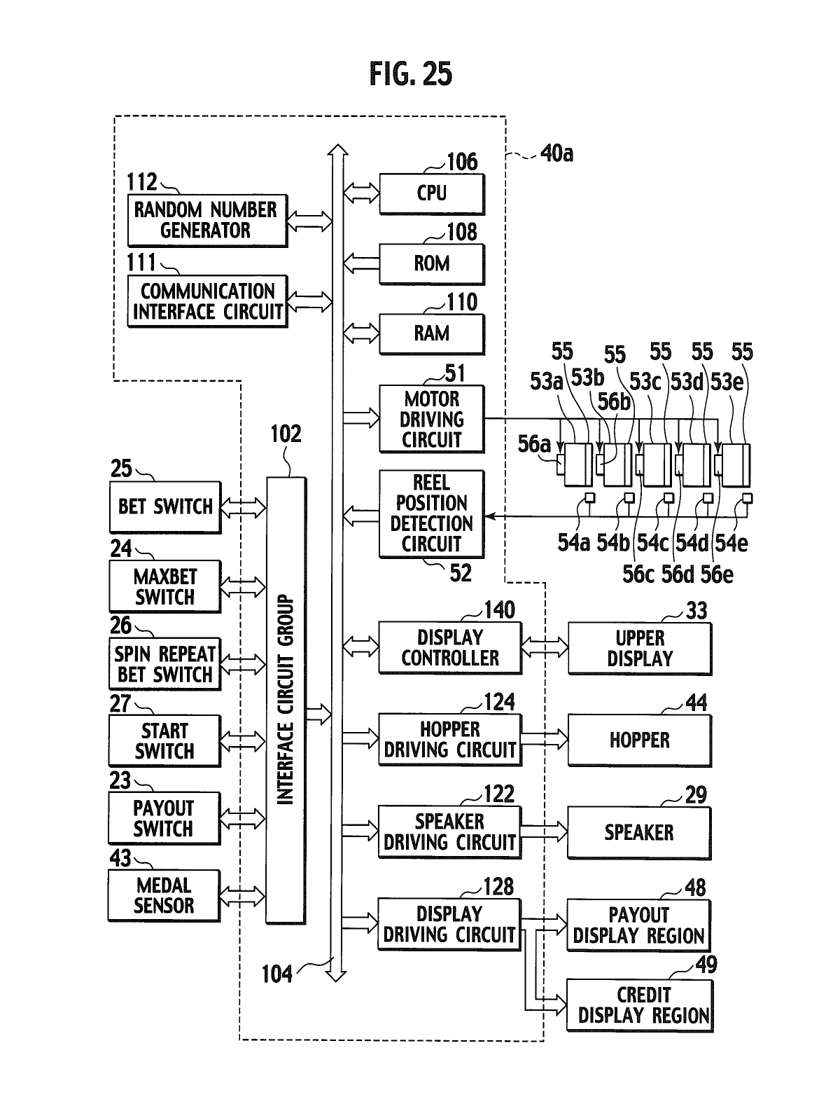

FIG. 25 is a block diagram showing an electric configuration of the controller 40a provided in the slot machine 10a according to the fourth embodiment and various devices connected to this controller 40a.

The upper display 33 shown in FIG. 24 is formed by a liquid crystal panel, and made to display various types of images (character images, for example) by a control of a display controller 140 shown in FIG. 25. Also, as shown in FIG. 25, the controller 40a has a motor driving circuit 51 and a reel position detection circuit 52.

The motor driving circuit 51 is connected to the pulse motors 56a to 56e for rotating the five rotation reels 53a to 53e, and rotates and stops the rotation reels 53a to 53e by outputting driving signals or stopping signals to the pulse motors 56a to 56e. Namely, when the start switch 27 is operated, the rotation reels 53a to 53e are driven into rotation by outputting the driving signals to the pulse motors 56a to 56e, and after a prescribed time (five seconds, for example) has elapsed, the rotation reels 53a to 53e are stopped by stopping the pulse motors 56a to 56e.

On the rotation reels 53a to 53e, identification codes 55 corresponding to the symbols are written, and data readers 54a to 54e for reading the identification codes 55 are provided at positions facing against the identification codes 55. The data readers 54a to 54e are connected to the reel position detection circuit 52.

The reel position detection circuit 52 identifies symbols according to the identification codes read by the data readers 54a to 54e.

Namely, when the rotation reels 53a to 53e are stopped after being rotated, the identification codes 55 written on the rotation reels 53a to 53e are read by the data readers 54a to 54e, and the stopped symbols are identified by the reel position detection circuit 52.

Then, the configuration of the slot machine 10a shown in FIG. 25 other than those described above is the same as the slot machine 10 shown in FIG. 2. Also, the slot game execution processing is the same as the processing procedure shown in FIG. 4 described above.

Then, even in the slot machine 10a according to the fourth embodiment in such a configuration, similarly as in the first embodiment described above, in a case where a winning combination formed by four numerical symbols and one currency unit symbol is realized on a payline set in advance when the numerical symbols and the currency unit symbols written on the circumferential faces of the rotation reels 53a to 53e are stopped, a prize of as much an amount as that indicated by these numerical symbols and currency unit symbol will be generated.

Consequently, the player can intuitively recognize the prize amount, without referring to the payout table or the like which indicates a correspondence between the winning combination and the prize amount, so that the slot game can proceed smoothly.

In the above, the embodiments of the slot machine according to the present invention have been described, but they are merely showing concrete examples and they are not for particularly limiting the present invention, and a concrete configuration of each means and the like can be modified in design appropriately. Also, the effects described in the embodiments of the present invention merely enumerate the most preferable effects arising from the present invention, and the effects due to the present invention are not to be limited to those described in the embodiments of the present invention.

What is claimed is:

1. A slot machine comprising:
a display configured to display a plurality of symbols, and
a controller configured to execute a unit game for rearranging symbols arranged on the display, and in a case where symbols rearranged on a payline on the display is a combination formed by numerical symbols and a currency unit symbol, generate a prize of as much an amount as determined by the numerical symbols and the currency unit symbol.

2. The slot machine according to claim 1, wherein the controller is configured to rearrange the numerical symbols first and the currency unit symbol last, at a time of rearranging a combination formed by the numerical symbols and the currency unit symbol.

3. The slot machine according to claim 1, wherein in a case where symbols rearranged on the payline is a combination formed by the numerical symbols and the current unit symbol and the currency unit symbol is different from a reference currency, the controller is configured to convert the prize into the reference currency base, and provide the prize in the reference currency base.

4. A slot machine comprising:
a display configured to display a plurality of symbols, and
a controller configured to execute a unit game for rearranging symbols arranged on the display, and in a case where symbols rearranged on a payline on the display is a combination formed by a sequence of numerical symbols and a currency unit symbol on a left end or a right end of the sequence of numerical symbols, generate a prize of as much an amount as determined by the numerical symbols and the currency unit symbol.

5. The slot machine according to claim 4, wherein at a time of rearranging a combination formed by the numerical symbols and the currency unit symbol, the controller is configured to rearrange the numerical symbols first and the currency unit symbol last.

6. The slot machine according to claim 4, wherein in a case where symbols rearranged on the payline is a combination formed by the numerical symbols and the current unit symbol and the currency unit symbol is different from a reference currency, the controller is configured to convert the prize into the reference currency base, and provide the prize in the reference currency base.

7. A slot machine comprising:
a display configured to display a plurality of symbols, and
a controller configured to carry out items described below,
a) executing a unit game for rearranging symbols arranged on the display,
b) making a transition to a second game, in a case where specific symbols are rearranged on a payline on the display or in a case where a prescribed number of specific symbols are rearranged on the display, as a result of executing the unit game,
c) carrying out a rearrangement from an arrangement of a plurality of symbols comprising numerical symbols and a currency unit symbol on the display, in the second game, and
d) generating a prize of as much an amount as determined by a combination of numerical symbols and a currency unit symbol rearranged on the payline.

8. The slot machine according to claim 7, wherein at a time of rearranging a combination formed by the numerical symbols and the currency unit symbol, the controller is configured to rearrange the numerical symbols first and the currency unit symbol last.

9. The slot machine according to claim 7, wherein in a case where symbols rearranged on the payline is a combination formed by the numerical symbols and the current unit symbol and the currency unit symbol is different from a reference currency, the controller is configured to convert the prize into the reference currency base, and provide the prize in the reference currency base.

10. A control method of a slot machine comprising:
a step in which a controller rearranges symbols arranged on a display, and
a step in which the controller generates, in a case where symbols rearranged on a payline on the display is a combination formed by numerical symbols and a currency unit symbol, a prize of as much an amount as determined by the numerical symbols and the currency unit symbol.

11. The control method of a slot machine according to claim 10, wherein the controller rearranges the numerical symbols first and the currency unit symbol last, at a time of rearranging a combination formed by the numerical symbols and the currency unit symbol.

12. The control method of a slot machine according to claim 10, wherein in a case where symbols rearranged on the payline is a combination formed by the numerical symbols and the current unit symbol and the currency unit symbol is different from the reference currency, the controller converts the prize into a reference currency base, and provides the prize in the reference currency.
